(19) United States
(12) Patent Application Publication
(10) Pub. No.: US 2006/0155423 A1
(43) Pub. Date: Jul. 13, 2006

(54) Automated energy management system

(76) Inventor: Lothar E. S. Budike JR., Villanova, PA (US)

Correspondence Address: Song K. Jung;MCKENNA LONG & ALDRIDGE LLP, 1900 K Street, N.W., Washington, DC, 20006, US

(21) Appl. No.: 11/030,948

(22) Filed: Jan. 10, 2005

(51) Int. Cl. G06F 19/00

(52) U.S. Cl. 700/286; 700/295

(57) ABSTRACT

An automated energy rate reduction and demand side sequencing management and analysis system bridges the gap between supply and demand side energy management. The management system enables energy consumer's to determine, automate and react in “real-time” to all of the cost sensitive energy billing components in a unregulated or regulated utility energy supplier rate as well as determine a “real-time” demand side operational sequence in order to drive new costs in their facility.

### BACKGROUND OF THE INVENTION

1. Field of the Invention

The invention relates to energy management, and more particularly to a system for providing both supply and demand side energy management.

2. Discussion of the Related Art

In order to understand the dynamics of energy pricing structures it is important to understand the difference between the two fundamental components in electricity, energy and capacity. Energy suppliers purchase these two energy components in the wholesale energy market in order to serve their customers.

Energy is the amount of power used over a specific period of time usually measure as kilowatts per hour (kWh). If an analogy was being formed to describe energy, think of the odometer of a car. If the car is moving, energy relates to the odometer reading, i.e., the number of miles the car has moved. It makes no difference about the speed of the car, the consumer pays for the movement of the car from point A to Point B, what you travel in miles is what you pay for.

Capacity is analogous to the speedometer; capacity is the instantaneous energy usage at any given point in time. Capacity is used to measure a consumers demand. Demand is the average amount of instantaneous power used by the consumer over a given 15 or 30 minute widow monitored by the utility. For instance, if a building owner were to turn on all the lights and HVAC in a building all at once, the load in the building would rise in order to provide power in an instantaneous time frame to ramp up the equipment. The utility will measure the demand of the building over a window of 15 or 30 minutes. This maximum rate of energy being consumed at any given window is the capacity. This would be similar to a speedometer in a car, if a car hits 80 miles per hour, the capacity level for the building is set at 80 mile per hour (or 80 kW).

Conventional energy management systems typically apply two fundamental strategies, “demand-side” management and “supply-side” management.

Demand side management has been in use for commercial consumers for many years. When performing demand side energy management of buildings, conventional systems utilize energy efficient devices and equipment to reduce the total amount of energy being used in the building. Conventional demand side systems are based on two general principles: energy or kWh reduction and capacity or kW reduction.

The techniques employed to realize energy reduction are simple, for example, replace a light bulb that consumes 40 watts with a light bulb that consumes 30 watts and there is a savings of 10 watts. This means that the consumer has saved 10 watts of power and hence they will save 10 watts of power charges on their electric bill. Various management systems and hardware has been proposed to reduce energy consumption which pertain generally to the installation and control of equipment and devices that operate more efficiently through the utilization of technology. Capacity (kW) reduction techniques are more complicated. Capacity reduction strategies consist of measuring peak loads in buildings and utilizing onsite generators or load curtailment to shave the peaks. Again, more limited, there exists prior art for devices and methods to “peak-shave” demand.

Capacity kW reductions are slightly harder to manage. Due to the fact that a utility needs to build a power plant to serve all the consumers during peak load, utilities have created a “Demand” charge, which allows the utility to charge a demand penalty for using more instantaneous “Demand” power at any given time. These were charged to the consumers as a “demand” ratchet charge. Consumers that had the ability to curtail load through an on-site generator or reduction of load could monitor these demand set-points and try to “shave” these demand charges which would reduce the overall demand obligation of the consumer. By lowering demand, the charges would also lower. Both of these strategies have been effective in the industry. Demand shaving has been the harder of the two to implement due to the fact that monitoring equipment and reaction time needed to be addressed in order to reduce the demand within the utilities billing window of 15 to 30 minutes.

Both of these strategies whether applied to kWh reduction thought more efficient devices or kW reduction through peak shaving fall under the general umbrella of demand side management where a building operator is trying to reduce energy usage or demand of the building to reduce operational costs.

Supply side management is generally known in the energy industry as strategies that enable commercial consumers to try and mange the supply (procurement) costs of energy to operate the facility. Energy suppliers purchase energy contracts in order to serve their customers' energy needs. To this end, the energy suppliers purchase two components of energy for each customer, an energy strip (strip is the term used in the commodity business) and a capacity strip. These strips can be purchased in advance from 3 months to one year. The goal of the supplier is to secure a majority of their load for customers in advance at a good rate and then purchase a small portion of energy from the spot market when additional power is needed.

Due to the volatility in the energy market, energy suppliers can be exposed to energy prices in the spot market that are extremely high. For example, the price of energy on a hot day can go from 3 cents per kWh to $1.00 per kWh in a matter of minutes. If the supplier is short in the market that day, they will need to purchase power at the higher price. In order to alleviate the risks of spot market pricing, suppliers offer consumers a bundled rate. The bundled rate allows consumers to purchase energy at a set rate, for example, 10 cents per kWh, for the entire year. With this rate structure, the supplier has minimized their risk of spot market pricing, because if you look at the customer over an entire year, the spot market price will become volatile only 30 to 60 hours per year. By charging a flat fee of 10 cents (which is generally much higher than the suppliers cost), the supplier has priced in the risk of the spot market in the bundled contract (i.e., the profit he makes during the normal operations covers the increased spot market prices). The problem is that the consumer is now paying this surcharge year around for a risk that may happen only 60 hours per year. This translates to a consumer paying 15% to 20% more for energy when purchasing a bundled contract.

Suppliers also offer index pricing instead of bundled. An index price is a price that is determined by the market in real-time. This means that what the customer pays for power is based on the market price. The supplier adds a surcharge for profit that is considerably less than the bundled market price. Generally, index or “real-time” pricing is only favorable to customers who have means to reduce load at any time in order to hedge the risk of a price spike in the market. For example, a steel mill that produces steel bars uses enormous amounts of electricity to produce the steel. The raw cost to produce a steel bar could be made up of an electricity component equal to 50% of that cost. If the steel mill decides the costs of electricity are too high, they can choose not to produce steel at that point in time and save money. If they stop producing steel for a few hours their load will drop and they will not be exposed to the volatile spot market price. Unfortunately, 99% of all commercial consumers do not have the option to shut down for a period of time nor do they have automated means for controlling load to hedge against the risk of volatile spot market pricing. Therefore, most consumers are typically in a bundled price structure from suppliers.

It should be noted that supply side management is a relatively new concept (since Deregulation EPACT 1992) due to the fact that electricity was historically sold as a bundled commodity to consumers from a regulated utility at a regulated rate with no alternate selection of energy suppliers to drive competition and lower prices. Distribution and transmission are still regulated and are sold under bundled rate packages by the local utility.

When performing supply side energy management of buildings, there is quite a limited base of related technical art that can perform such type of management. Certain related art utilize “real-time” energy rates in order to help a consumer select a different rate class. There is also related art as to using a combination of “real-time” rates with energy load building usage patterns to help manage the cost structures of energy by looking at the two and beginning to select options for the customer. This strategy, whether applied to “real-time” rates or a combination of load usage and “real-time” rates all fall under the general umbrella of Supply Side management where a building operator is trying to select a supply side rate and select options to reduce electricity procurement costs.

However, regardless of whether the consumer elects to perform a demand or a supply side energy management program, the consumer is still at a great disadvantage in achieving maximum savings potential because the two processes are independent of each other. Under these two independent processes, the best savings the customer can hope to achieve for supply side savings is either a reduced or “real-time” rate from the energy supplier (regulated utility or unregulated supplier). As for demand side management, the consumer may have access to a system that reduces load usage in order to save kWh reflected in the electric bill. The reduced or “real-time” rate from the energy supplier still includes all of the surcharges and profit margins that exists when delivering the power to the consumer. The demand side strategy saves net dollars from reduced kWh usage but with the sheer dynamics of the energy supplier's rate structure, the consumer never really knows “when” is the best time to manage their demand side energy usage in order to directly impact the suppliers price of power. In short, there is a very large gap that exists between the convergence Demand Side Management and Supply Side Management as it relates to creating an equilibrium and creating the maximum savings potential for the consumer.

### SUMMARY OF THE INVENTION

Accordingly, the invention is directed to an automated energy management system that substantially obviates one or more of the problems due to limitations and disadvantages of the related art.

An advantage of the invention, is that it provides an energy management system that optimizes and merges supply side procurement with demand side management in order to ultimately provide consumers a greater level of energy efficiency.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, a method of managing energy is provided that comprises: periodically receiving data relating to the acquisition of energy; periodically receiving data relating to the rate structures of energy; periodically receiving data relating to the consumption of energy for a particular customer; periodically receiving customer defined facility operational schedules; periodically receiving customer defined curtailment options; calculating various energy acquisition options for the customer; and managing the customer's energy consumption based on the acquisition options selected and predefined curtailment options.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates exemplary supply side inputs in accordance with an embodiment of the invention.

FIG. 2 illustrates exemplary demand side inputs in accordance with an embodiment of the invention.

FIG. 3 illustrates exemplary building schedule inputs in accordance with an embodiment of the invention.

FIG. 4 illustrates exemplary outputs in accordance with an embodiment of the invention.

FIG. 5 is a flow chart illustrating a method of managing the acquisition and consumption of energy according to an exemplary embodiment of the invention.

FIG. 6 is a functional block diagram of an energy management system according to an embodiment of the invention.

### DETAILED DESCRIPTION OF THE ILLUSTRATED EMBODIMENTS

Reference will now be made in detail to an embodiment of the invention, an example of which is illustrated in the accompanying drawings.

The invention relates to an automated energy rate reduction and demand side sequencing management and analysis system utilized to drive further energy saving efficiencies for commercial consumers by bridging the gap between supply and demand side energy management. This management system enables energy consumer's to determine, automate and react in “real-time” to all of the cost sensitive energy billing components in a unregulated or regulated utility energy supplier rate as well as determine a “real-time” demand side operational sequence in order to drive new costs in their facility.

The energy management system according to an embodiment of the invention processes and analyzes different input data regarding consumers' supply side energy pricing and demand side operational control sequences for the facility (“savings aggressiveness”). Based on various inputs, the system determines the most cost efficient manner to operate the building to achieve the savings objectives desired by the consumer. The system then automatically engages and sets specified equipment or devices to carry out these operational guidelines.

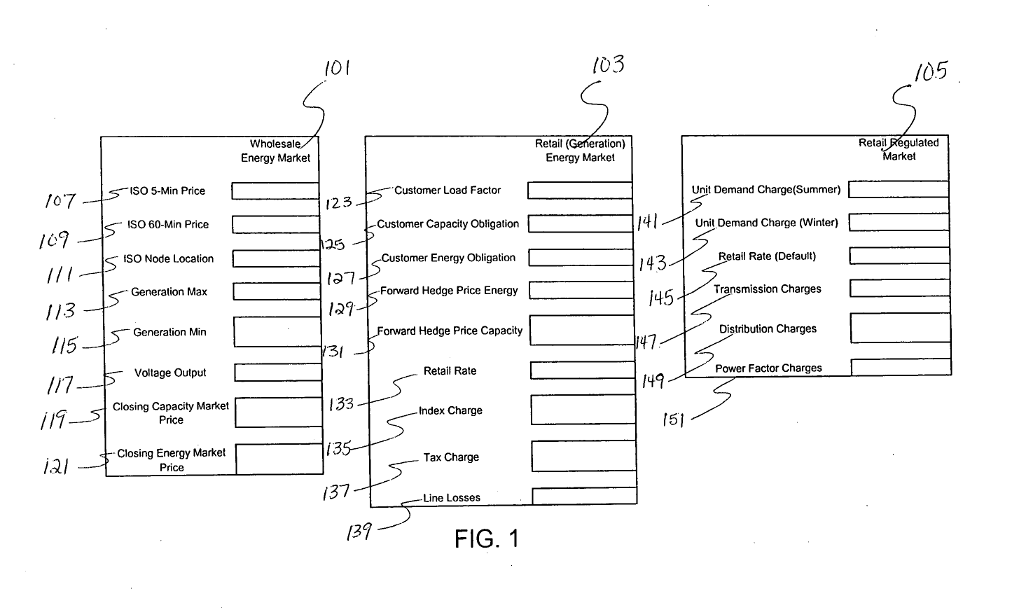

According to an embodiment of the invention, the supply side inputs comprise three different sequences of energy procurement and purchasing data. The first of these input sequences, as shown in FIG. 1, is actual wholesale pricing received from the wholesale Independent System Operator (ISO) market. The ISO entities operate the electricity grid system and act as the “clearing house” for electricity prices in the wholesale market. Energy suppliers purchase wholesale electricity and capacity from the ISO market and energy producer's sell electricity and capacity to the wholesale market. Electricity is traded every 5 minutes and settles at a final price every hour. Capacity is traded on longer-term time instruments such as a week, month, or yearly trades. The ISO provides “real-time” data/information to the management system every five minutes through, for example, standard XML Internet technology.

The first wholesale input as shown in FIG. 1 is the ISO 5 minute price. Electricity is a commodity that may change price every five minutes. The primary reason for this is that the generators use various fuels to generate the electricity and these fuels have various costs to operate. Hence, an oil burning generator plant pays more for fuel costs than a coal plant because oil is more expensive than coal. Every five minutes, the system records and processes the 5-minute trading price 107. The 5-minute trading price is designed to be an “early detection alarm” that notifies the system that prices are becoming volatile, i.e., rising or falling. Although electricity is traded every five minutes, suppliers buying power and generators selling power only use this price as a baseline indicator. The trade price is established after one hour of trading where these five minute trades are averaged.

The second wholesale input as shown in FIG. 1 is the ISO 60 minute price 109. Every hour, the system records and processes the 60-minute trading price. The 60-minute trading price 109 is designed to represent the baseline wholesale hourly trading price for electricity. This baseline price will be used throughout the model to compare wholesale costs to retail costs and process strategies as it relates to financial efficiency options for the consumer.

The third wholesale input as shown in FIG. 1 is the ISO node location 111. The ISO's grid serves millions of consumers through multiple states. Throughout this grid, there are various regions and locations where it is difficult to deliver power during certain times throughout the year. This is evident mostly on hot days where electricity usage is very high. The price for electricity at various nodes throughout the grid may change at different rates. For instance at 2PM on a given day, the price could be different at two parts of the grid. For this reason in order to effectively determine the true “real-time” wholesale cost of electricity for the consumer, the system uses the price at the node where the consumer is located. This node location input allows the system to search the price that is reflected at the consumers' actual node location on the grid.

The fourth wholesale input as shown in FIG. 1 is the Generation Maximum Alert 113. The Max Gen Alert is an alert that signifies to the ISO that there is a shortage of power and that all available generators should spin up to production and offer all of their available generation. This alert is used primarily when there is shortage on the grid, and the ISO is looking for power to provide to all of the consumers on the grid. This input acts as an early detection system to warn the management system of a potential volatile price point or price spike.

The fifth wholesale input as shown in FIG. 1 is the Minimum Generation Alert 115. This input signifies that the ISO is telling the generators to stop producing electricity because there is more supply than demand. This is a key indicator that also acts as an alarm and trigger, that allows the management system to understand when there is an abundance of electricity in the market, and when the consumer can actually not worry about purchasing energy from the wholesale market. When there is a Minimum Generation Alert, it typically means that the wholesale price of power will be reduced and that it will be cheaper to purchase power because there is an abundance of power.

The sixth wholesale input as shown in FIG. 1 is a voltage data point 117, which signifies the amount of voltage going through the grid. This is a significant data input because as the grid begins to act in a volatile manner, the grid can actually reduce voltage going through the grid system in order to curtail power. When there is a voluntary or involuntary voltage reduction, it is a key indicator to the management system that there is a shortage of power and demand is exceeding supply. These could mean 1) a quick spike in 5-minute energy pricing, or 2) there will be a volatile price spike in the market.

Another wholesale input is the capacity market price 119. The ISO, as discussed above, acts as the clearinghouse for all energy pricing. The Closing Capacity Market Price is an actual price in which multiple bidders in the market have now bid on energy and capacity and now they have closed in on a price for capacity. This capacity price is indicated in the forward market in different segments. The segments are broken down into a daily, weekly, monthly, and yearly capacity prices. These are called forward-capacity instruments. This input enables the management system to understand what the forward capacity market will look like in order for the system to determine whether it would be better to hold off purchasing in the forward market, or perhaps using another source of capacity in order to provide power to the consumer.

Along with the closing capacity market price there is a closing price for energy. This is called the closing energy market price 121. As discussed above, energy will trade and change in price every 5 minutes. The hourly prices are then recorded. At the close of each hourly price, a transaction occurs to finalize the closing price. It is not an instantaneous process, so in this input, the final closing price of every hour for every energy in the market on a real-time basis is recorded. This gives the system the information it needs to build trends in the costs of energy in different months against different temperatures in order to verify what the actual cost of energy was.

The second supply-side sequence 103 of inputs is for retail market generation. The Retail Energy Market represents data received from the Retail Energy Supplier. The Retail Energy Supplier is the supplier who is typically supplying the generation portion of electricity to the end-use consumer. It is this retail supplier who purchases energy and capacity from the wholesale market, bundles it into a portfolio for their clients, and then resells that energy to consumers on a daily basis. The Retail Energy Supplier chooses different generators and different people to contract with. They have multiple inputs and they basically structure the financial contract between the consumer and themselves for the generation portion of the electricity bill. It is important to remember that the Retail Energy Supplier is also trying to reduce their risk because they are purchasing the majority of their energy form the forward market. Typical inputs received from the retail market according to the invention are as follows.

Customer Load Factor 123. The first critical input for the retailer is Load Factor. Every customer that needs electricity has a certain load factor. If the customer is an office building type that typically runs from 9 to 5, that customer's load factor would be 50 percent. If the customer is a steel mill that runs 24 hours per day, that customer's load factor would primarily be 100%. Since energy needs to be bought and purchased in the wholesale market in even blocks, it is critical to understand the consumer you are selling energy to. That is why the Customer Load Factor is so important. Hence, if the retail supplier purchases a large block of energy, but can only sell 50% of that energy to a consumer, it must find another customer to compensate for the other portions of that energy block. It is difficult to compensate and marry each consumer within the portfolio perfectly to the blocks of energy. That is why a consumer with a lower load factor typically pays the higher price for energy.

The management system uses the Load factor as a means for determining where the consumer has the ability to save energy or the ability to negotiate a better price by raising their load factor. If the end use consumer can control the load operation within their facility, they can increase their load factor. When their load factor is increased, that would mean that they are entitled to a cheaper price. This is a parameter that is constantly monitored by the system.

Customer Capacity Obligation 125. Each customer has a capacity obligation. This means that the customer has a certain amount of capacity that is operating within their facility. This capacity obligation typically reflects the customer's peak capacity, which is typically only reached in August or September on a hot summer day. The Peak Capacity obligation is a critical point because it determines the peak capacity point of the building. The management system uses this critical peak point as a means to benchmark the facility's operational parameters and also to give the facility the opportunity not to exceed this benchmark for capacity in order to negotiate better with the retail supplier and reduce the capacity obligation. The higher the capacity obligation is for the end-use customer, the higher the capacity obligation the retail supplier has to secure from the wholesale market. So the lower the capacity obligation, the lower the securitization needed in the wholesale market for capacity. In addition, the management system can search out new forms of capacity to replace the existing capacity hedge.

Customer Energy Obligation 127. In addition to the customer's capacity obligation, it is also important for the retailer to understand the customer's energy obligation. Again, the retail supplier needs to secure enough energy in the wholesale market in order to serve that customer. So once again, the retailer will clearly understand what is the maximum energy obligation for that consumer in order to go out and purchase enough power for that consumer. The management system also monitors that critical energy obligation, because this obligation provides another benchmark of how to determine when the customer is operating under their energy obligation in order to produce savings.

Forward Hedge Energy Price 129. The Forward Hedge Energy Price is the price of energy that the retail supplier has secured in the forward market. This forward market price is the price of energy that the supplier has purchased in order to serve that customer. This is an important forward price, because it determines the difference between the actual real-time price and the closed forward market price. Hence, a supplier will only purchase 70 to 80% of the needed energy to supply a customer, hoping that the risk in the real time market will be less exposure to the forward market in order to blend the two markets in order to buy down a cheaper price to supply that customer. Again it is used as a risk tool. The management system uses this information in order to determine where the supplier is within this whole sequence of purchasing, in order to determine the least cost route of power of the wholesale market vs. the retail energy supplier's price.

Forward Hedge Capacity Price 131. Similar to the Forward Energy Price, the retail supplier has purchased capacity in the forward market. This forward market price is the price of capacity that the retailer has obligated itself to purchase in order to supply energy to its customer. These instruments are called strips, and these forward instruments are purchased in weekly, monthly and yearly components. These components often encompass the securing of capacity obligations in the forward market. Again, the management system uses this information to baseline the differences between the cost of the retailers versus the cost of wholesale market price

Retail Rate 133. The Retail Rate is typically a rate which combines the forward capacity and forward market price, plus all the surcharges in it, in order to offer a consumer a bundled retail rate. The retail rate to a consumer is typically a one-price rate that the consumer can pay in order to pay for their electricity. Hence, if a retail supplier has secured a strip of capacity and an amount of energy to supply that customer, if you add that together and add all the necessary risks, profits, taxes, and surcharges, it typically comes up to a bundled retail rate. The management system uses this retail rate in order to baseline the actual costs of the retailer versus the actual wholesale costs in order to determine whether it would be better to purchase energy from the wholesale market or stick to the retailer's retail rate. It can turn out that the retail supplier has secured energy in the forward market at a much cheaper rate than the wholesale market at any given point in time, so the system has to compare these two numbers in order to determine the best course of action for the consumer to save the most amount of money.

Index Rate 135. The index rate is the index price of power. Each energy retailer has what is called an Index Rate. This index rate is the ability for the retail supplier to buy electricity directly from the grid in the spot market. This is called the index price. Index prices are a true transfer of a real time price—5 minute or 60 minute closing price—back to a supplier. So if the supplier chooses to purchase in the index market, the supplier can then purchase an index price into the system, and the management system will then transfer a price exactly at the index rate. It is important that the index rate is baselined against the forward energy price rate, which is then also indexed against the capacity application as well, in order to determine the ultimate savings to the consumer.

Line Loses 139. The line loss is a factor that determines how much energy will be lost in translating electricity from the generator out to the consumer. From the generator to consumer, there are typically many miles of grid lines. As electricity goes through different capacitors, transformers, and distribution centers through out the gird, there is actually a net loss of electricity. So if you purchase a certain unit of electricity from the grid, you need to take into account that there will be loss in that energy in order to deliver it to the consumer. These losses are typically a percentage point and are added into the price of power. Therefore, if you determine that you need to provide 3 units of power then you will need to purchase 3.3 units of power from the wholesale market in order to compensate for the line losses. It is important for the management system to understand the line losses in order to understand whether the line losses are net or gain of the actual rates and prices to prevent the management system from misinterpreting line losses as a profit center for the retailer, or a loss center for the consumer.

Tax Charges 137. The tax charges differ for different ISO's and for different places where you are actually delivering power. It is also important to understand the different tax charges so the management system does not mistake tax and surcharges as well as other taxable transition charges for profits or losses within the management system.

All retail suppliers use the above-referenced inputs in order to manage their portfolio. However, the consumer may or may not have access to all of the information in these retail inputs. The retailer offers multiple rates and strategies to consumers in order to save power. The management system can operate in two separate segments. The first segment (Scenario A), would be that the retailer is intimately involved with the consumer, offers various key information for the input model, and a blanket profit agreement structured between the consumer and the retailer in order to provide power giving both parties an opportunity to profit and save the maximum amount of energy while reducing both party's risk. Another scenario, (scenario B), would be that the consumer files for a license with the wholesale market and receives this information directly from the market (as a retailer would) in order to purchase real-time power directly from the wholesale market. This is where the consumer would select a retailer to just act as a more of a broker or agent rather than an actual retail supplier. In that case, all of the inputs would be given to the consumer, and the consumer would be able to make their own decision on whether to buy index power, or real-time power, which is index power, or actually purchase from the retail suppliers. It is important to note that in today's economy and ISO rules, the consumer must have an agent as a supplier in order to purchase from a retail market. However, in certain ISO's, consumers can now purchase real-time power directly from the ISO if they meet certain ISO obligations.

The third supply-side sequence 105 of inputs is for the Retail Regulated Market. The retail regulated market is the actual transmission and distribution. Throughout deregulation, the United States has only deregulated one portion of the electric bill, which is generation. Hence unregulated energy suppliers offer unregulated generation to consumers. The other two portions, which are transportation and distribution, have remained a regulated entity by the utility companies. The utility companies provide transmission, which is the delivery of power from the generator plant through the high voltage wire to the substation. Distribution is defined as the delivery of the electricity from the substation through the customer's electric poles, which is outside their facility, into their distribution panel within their facility. Transmission and Distribution is typically known in the industry as “pipes and wires”. It is important that the dynamics of the supply side inputs on the regulated pipes and wires side be considered as a basis of the management system.

Unit Demand Charge Summer (kW) 141. The Unit Demand Charge (kW) Summer is defined as a unit of energy, called “demand”, for deregulated utility territory. The word “demand” as used by the utility, means the same as “capacity” to the wholesale market. So for instance, the utility will offer a unit of demand to a consumer, the wholesale market would offer a unit of capacity to the unregulated supplier. For discussion purposes, since utilities and regulated entities utilize the term demand, we will call it demand. However it is important to note that a unit demand charge winter kW input is similar as a summer financial capacity instrument. Now, in order to clearly define a unit demand charge summer (kW) for a utility, it is important to understand the dynamics of how a regulated utility sets the price for this type of installed capacity or summer demand unit. The regulated utility company has to request a set charge for a unit of demand by their local public utility commission. A set unit of demand is a unit that defines how much money it costs that utility to generate the capacity at a peak moment during the summer months. That is why it is called a summer unit of demand. The utility will offer a rate case to the Public Utility commission, and then they will get a unit charge approved. For instance, a unit demand charge in central New Jersey is approximately $9.30. This is a unit demand charge. It is important to remember that all regulated pipes and wires providers have unit demand charges in the summer, and also have unit demand charges in the winter. This unit demand charge is important to our management system, because if we can save one unit of demand, we've saved that amount of money in that demand charge. Hence if a customer is using 300 units of demand in the month of June, and we can reduce that customer by 50 units at a unit costs $9.60, you've achieved an instant savings of $480 (i.e., 50 time $9.60).

Unit Demand Charge Winter (kW) 143. The Unit Demand Charge (kW) winter is defined as a unit of energy called “demand”, for deregulated utility territory. A unit demand charge in central New Jersey is approximately $3.85. Hence if a customer is using 300 units of demand in the month of November, and we can reduce that customer by 50 units at a unit cost of $3.85, you've achieved an instant savings of $192.50 (i.e., 50 times $3.85).

Retail Rate 145. Retail rate is the rate that the deregulated utility charges the consumer, also referred to as the default rate. In certain deregulated markets, the consumer is sometimes locked into a retail rate, which means that there is no potential unregulated supplier serving them, and they are locked into certain retail rate. This retail rate is often published, and it is important for the management system to understand the retail rate in order for the management system to determine whether in certain time frames it would be beneficial to go back to the supplier's retail rate.

Distribution Charges 149. Along with the regulated bill, there is a data point for distribution. The regulated utility will go to the public utility commission and ask for a surcharge in order to offer distribution services to the customer. As discussed above, distribution means that from the local pole to your facility is a service charge to bring the power into your facility and that is the rate that is plugged into there. It is important for the management system to understand the distribution charges because if you bring in less power, less demand, less energy though your distribution system, then you should be charged a lesser amount on a distribution rate, because it is billed to you per kW that is coming into your facility, and it's important for the management system to understand that input in order to make sure that the system is not overcharging for distribution.

Transmission Charges 147. This is similar to distribution. It is the charges tot bring the power that the utility goes back to the PUC and charges the consumer to bring the power from the generating station out to the high-tension wires and to the distribution substation. So this is a rate what is brought down, and is charged per unit of energy and is a rate that is important to our management system because it allows us to optimize the costs of transmission and determine where cheaper transmission could be provided in the future by purchasing power at different distribution points in the wholesale market from different area nodes.

Power Factor Charges 151. Power factor is sometimes a penalty imposed on the utility bill. Due to the conditions of some facilities, there are penalties imposed on those consumers by the utility which are called Power factor penalties. Therefore, it is important that the system determine if there is anything forbidding the consumer to achieve savings due to bad voltages and bad power factor within their facility.

In order for the management system to effectively control the consumer's power usage the system needs to correctly break down and analyze the demand side of operations for a particular Consumer's facility. The amount of electricity required to operate a facility varies according to the type of facility. In addition, the operational usage of a particular facility fluctuates due to the weather (e.g., hot or cold) and/or the day of the week. For example, in the summer months, electricity usage due to the heat is predominantly higher than in the winter months. Hence there is a regulated winter peak and summer peak, which are two different amounts of money. It costs a lot less money to generate power in the wintertime due to the fact that in most regions, transporting power on high temperature days is difficult due to the fact that on hot days it is harder to transport electricity, which makes it more volatile and more expensive to do so. Accordingly, the demand side inputs according to an embodiment of the invention are divided into various load sequences.

The first demand load sequence relates to the Operational Load Data of the Facility 200. Each building has its own operational profile. This means that any given building or facility will consume a certain amount of energy to perform the basic tasks within the facility. For example, a commercial building typically consumes 35-45% of its energy in lighting, 35-45% in heating, ventilation and air conditioning (“HVAC”), and anywhere from 5-25% in miscellaneous power consumption from, for example, computers within the facility, or a certain process that the facility is doing, such as machinery if it is a hospital, or a production line if it is a manufacturer. But in general terms, lighting and HVAC are the primary drivers in most facilities throughout the commercial customer base. The operational load data 200 is a breakdown of each customer's profile on a seasonal and per month basis. The first input in the sequence is the total operational kW 210 which is the total amount of energy kW consumed for that consumer for the entire year. The second input is the summer kW 212 which is an average of the peak kW of the facility through the months May, June, July, August, and September. The monthly peak kW 214 for each month of the year is the peak demand the facility hit in the particular month. hat is the peak amount of demand for that facility hit in the month of May. The Winter peak kW 216 is the average of the winter peak kW for the months of October through April.

Another demand load sequence is the HVAC breakdown 202. This sequence, like the operational sequence, is broken down by seasonal peaks, e.g., mean for year, summer and winter, and monthly peaks. However, unlike the operational sequence, the HVAC sequence pertains only to the energy consumed/demanded by the HVAC systems. HVAC load (100%) refers to the total energy kW used for air conditioning and heating throughout the course of the entire year and so on as discussed above with respect to operational load.

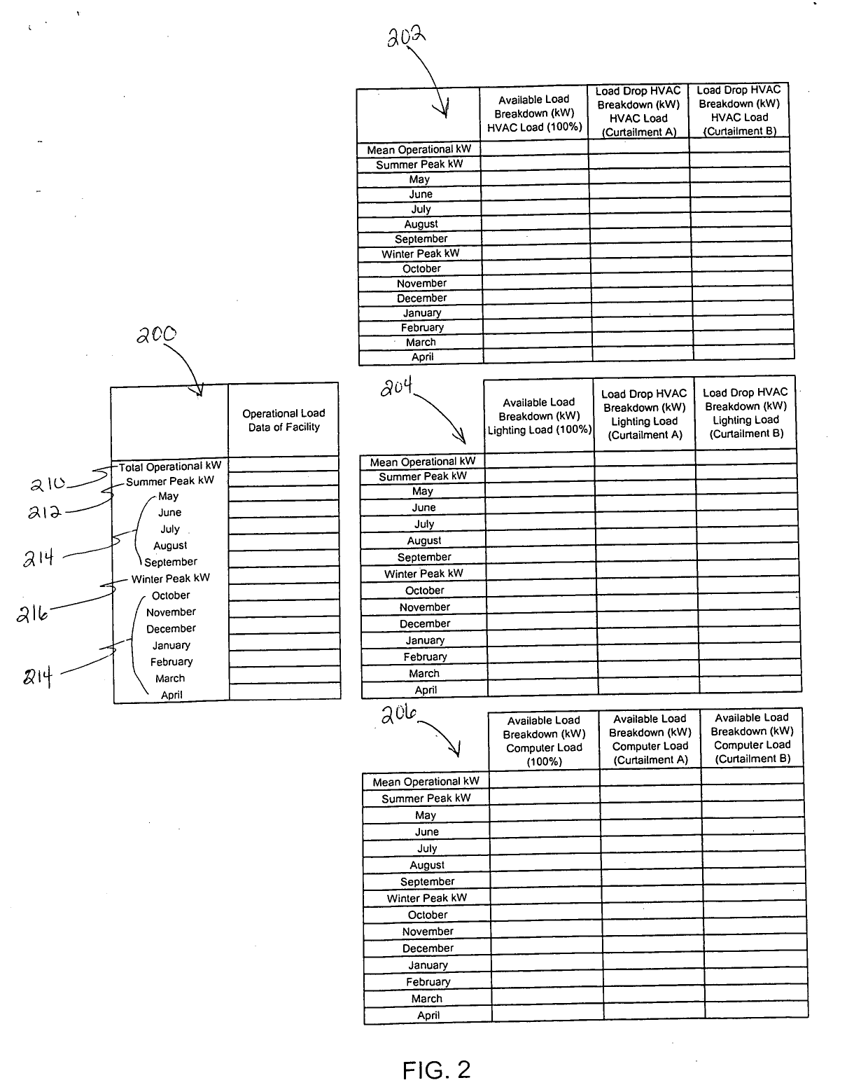

In addition to the HVAC load sequences, the system also includes load sequences for the lighting load 204 and computer load 206. These sequences, like those discussed above, are broken down on a seasonal (year, summer and winter) and monthly basis. They also include curtailment sequences (discussed in greater detail below). It should be noted that while HVAC, lighting, and computer load sequences are illustrated in FIG. 2, other sequences may be employed without departing from the scope of the invention.

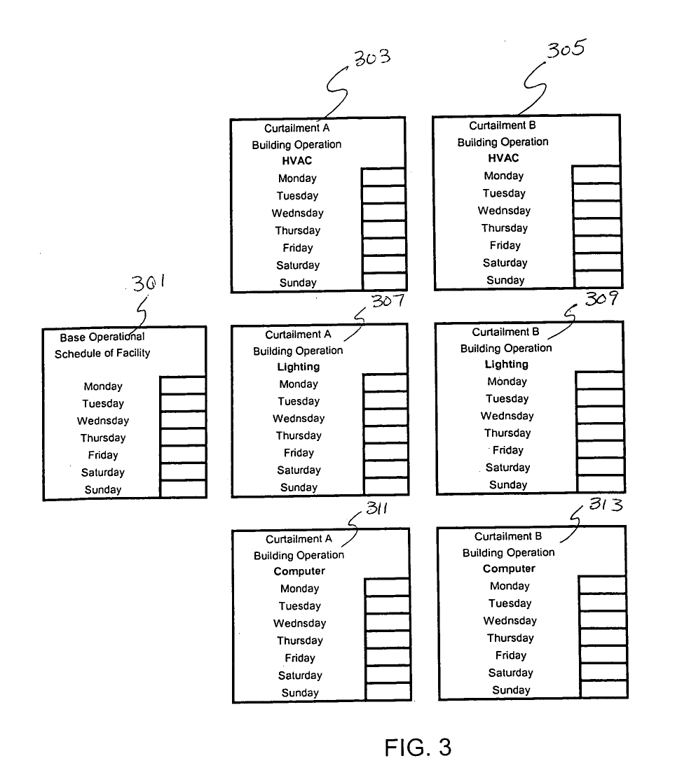

Curtailment schedules (discussed in greater detail below with respect to FIG. 3) represent reductions in energy consumption by controlling the operation of various equipment, such as lighting HVAC and the like. Energy consumption may be reduced, for example, by dimming the lights after 6 pm or turning the AC off after work hours. In addition, energy consumption may be further reduced by deviating from normal operational schedules. Accordingly, the Load Breakdown HVAC Curtailment A measures the amount of energy kW that is available to curtail if this curtailment A was executed within the building. In other words it represents that the amount of energy that would be saved by implementing a particular curtailment schedule. The load drop HVAC Breakdown is the peak kW that would be able to be dropped if someone did an HVAC curtailment within the building. So the mean operational kW is an average of all the curtailment kWs that can be averaged throughout the whole year, the summer peak kW is the kW that is an average of kW shedding or curtailment for May through September, and so on. It should be noted that upon initialization of the system estimated values may be used where actual historical information regarding energy consumption are not available. For example, the yearly operational values may be estimated based historical data of representative of a similar facility until actual consumption data is gathered.

FIG. 3 illustrates a block diagram of various exemplary facility operational schedules according to an embodiment of the invention. It should be noted that the actual operational schedules involve various inputs/commands and are represented here for simplicity merely as daily schedule blocks. However, one skilled in the art would appreciate that the facility schedules may be entered using any one of a number of known user interface systems. The base operational schedule of the facility is the operational parameters that the facility will execute on a daily basis. This means that the building is normally in operation for a certain schedule on Monday through Sunday. During that time there are different schedules that the building will adhere to. In general terms during the course of the year, the buildings will operate in the same fashion on a daily basis throughout the year.

Base Operational Schedule of Facility 301 is the base schedule of the facility without any curtailments and without any other operational things going on. The base schedule is intended to be the schedule used on a day in and out basis. This schedule is defined as the base schedule for Monday through Sunday. This base schedule is pre-determined by the building owner and it will execute every day in and out with no type of central control.

HVAC Curtailment A Operation 303 is the first curtailment schedule for the HVAC. This means that the building operator has predetermined a savings schedule by curtailing air conditioning. For example, the building manager may set limits the temperature the HVAC system may be set to during the day. The building manager can determine how much energy would be saved by employing a specific curtailment schedule using the demand load breakdowns of the curtailment schedule in the previous screens. Accordingly, the building manager can design one or more schedules that suit his needs at different times. HVAC curtailment B Operation represents a second curtailment schedule predefined by the building manager. Likewise, lighting curtailments 302 and 309, and computer curtailments 311 and 313 represent predetermined savings based on control of the lighting systems and computers.

The demand or consumption inputs discussed above are generated from controllable equipment installed within the consumer's building(s). For the purposes of this disclosure the phrase “controllable” refers to various equipment connected to a processor such that the operation of the device may be automatically or remotely controlled. An exemplary control system that may be utilized by the management system of the invention is disclosed in co-pending application Ser. No. 10/700,058, filed Nov. 4, 2003, titled “Wireless Internet Lighting Control System”, which is incorporated herein in its entirety.

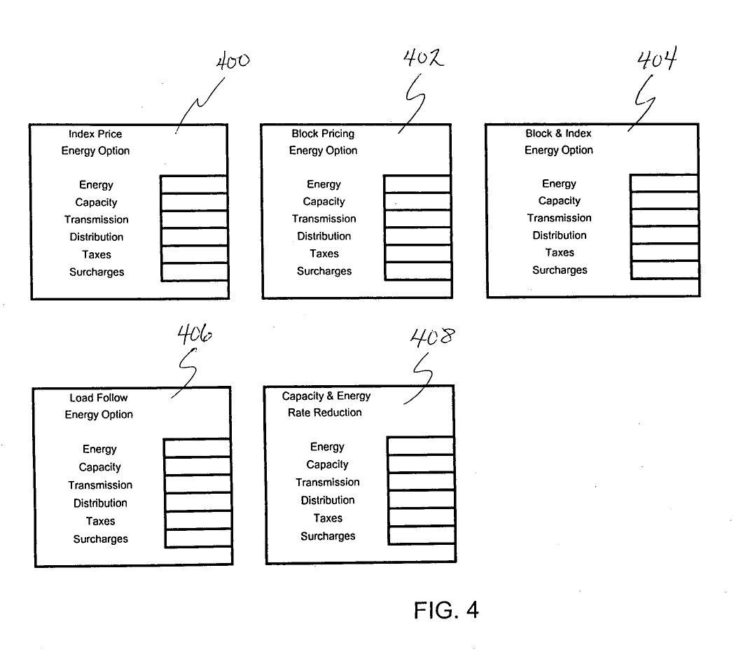

Exemplary outputs of the management system in accordance with the invention are shown in FIG. 4. While these outputs are shown in various groups, one skilled in the art would appreciate that the data can be displayed or presented in numerous formats utilizing any of a number of user interfaces.

Index Price Option 400, Block Pricing Energy Option 402, and Block and Index Energy Option 404 provide various energy pricing option available. These outputs provide price breakdowns information for energy, capacity, transmission, taxes, surcharges and the like based on the various acquisition options (index, block etc.)

Block Pricing Energy Option—“Block” means the purchase of a block of energy in the retail market, and this would also be known as retail rate. In some cases where that is the cheapest scenario, we would have the Block Pricing Energy Option as an output for the management system.

Block & Index Pricing Energy Option—This means that the management system would be a combination of (0098) and (0099), and secure a block of energy but also load follow into the market in order to produce an index option as well.

Load Following Energy Option—This is the straight energy hedge option where a block is purchased at a retail rate and the system would follow the demand load into the market and then curtail as needed in order to save energy.

Capacity & Energy Rate Reduction Option—This is an option that can operate independently and in addition to all the other options. This is basically the option where the system is constantly trying to reduce the regulated transmission and distribution choices in the facility in order to save energy through the management system.

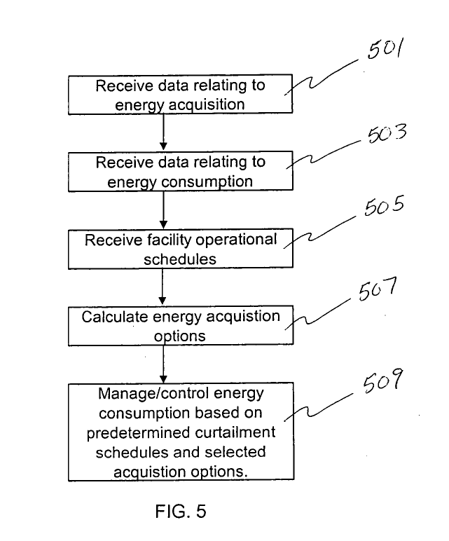

FIG. 5 is a block diagram of an energy management system according to an embodiment of the invention. At step 501, the system periodically receives information relating to energy acquisition costs. At step 503 the system receives information regarding energy consumption for at least one customer. The at least one customer also provides operational schedules for their facility at step 505. The system monitors changes in energy acquisition costs and calculates variously energy acquisition options based on the current costs and the customer's historical consumption at step 507. Based on the acquisition option(s) selected, the system then controls energy consumption at step 509 in accordance with the predefined curtailment schedules.

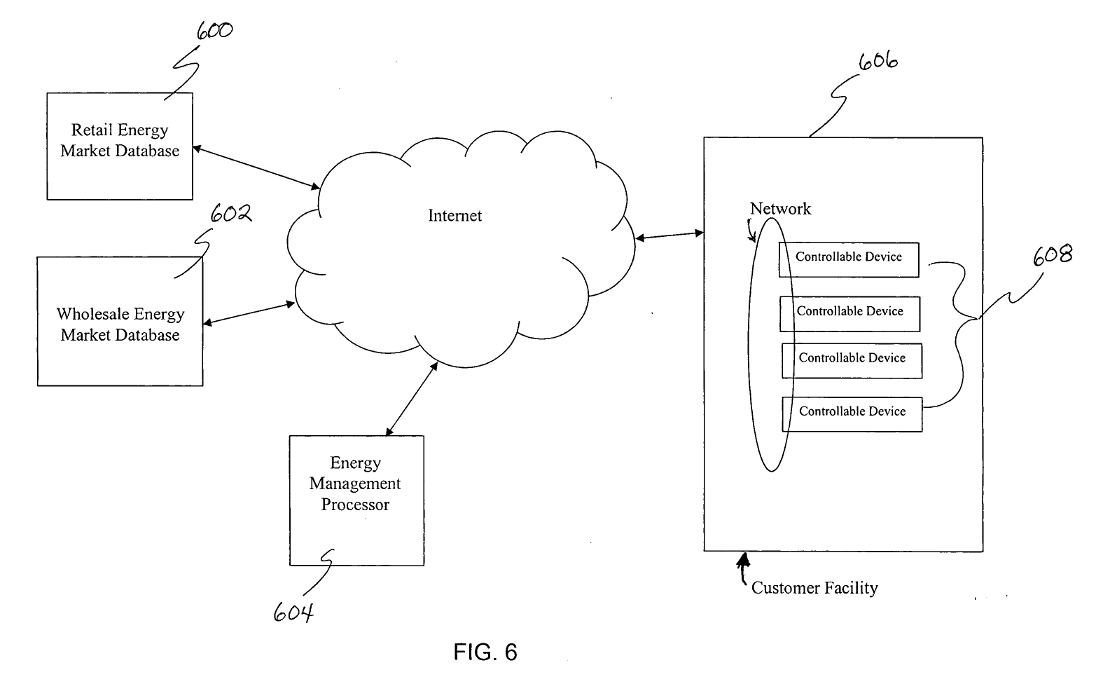

FIG. 6 is a block diagram of an energy management system in accordance with an embodiment of the invention. The energy management processor 604 periodically receives data relating to the acquisition of energy from retail energy market database 600 and wholesale energy market database 602 via the internet. In addition, the management processor periodically receives data relating to the consumption of energy for a particular customer from each customer facility 606. The customer facility 606 transmits and receives data from a plurality of controllable devices 608 via a network.

It will be apparent to those skilled in the art that the various modifications and variations can be made in the invention without departing from the spirit or scope of the invention. Thus, it is intended that the invention cover the modifications and variations of this invention provided they come within the scope of the appended claims and their equivalents.

What is claimed is:

1. A method of managing energy acquisition and consumption, comprising:
periodically receiving data relating to the acquisition of energy;
periodically receiving data relating to the rate structures of energy;
periodically receiving data relating to the consumption of energy for a particular customer;
periodically receiving customer defined facility operational schedules;
periodically receiving customer defined curtailment options;
calculating various energy acquisition options for the customer;
managing the customer's energy consumption based on the acquisition option selected and predefined curtailment options.

2. The method of claim 1, wherein periodically receiving data relating to the acquisition of energy comprises:
automatically receiving supply and demand data from the wholesale energy market.

3. The method of claim 1, wherein periodically receiving data relating to the acquisition of energy comprises:
automatically receiving supply and demand data from the retail energy market.

4. The method of claim 1, wherein periodically receiving data relating to the consumption of energy for a particular customer comprises:
periodically receiving data relating to the energy consumption of at least one controllable device associated with the particular customer.

5. The method of claim 1, wherein receiving customer defined curtailment options comprises:
providing access to each individual customer in order to allow the customer to enter specific energy strategies relating to at least one controllable device associated with the customer.

6. The method of claim 1, further comprising:
supplying at least one energy acquisition option based on the received acquisition data and historical consumption data for the specific consumer.

7. The method of claim 1, wherein managing the customer's energy consumption based on the acquisition option selected and predefined curtailment options comprises:
utilizing automatically controllable equipment;
monitoring the energy consumption of the controllable equipment; and
altering the energy consumption of the devices based upon a predetermine curtailment schedule.

8. A system for management energy acquisition and consumption, the system comprising:
at least one processor; and
at least on controllable device associated with each individual consumer, wherein the at least one processor is configured to:
periodically receive data relating to the acquisition of energy;
periodically receive data relating to the consumption of energy for a particular customer;
periodically receive customer defined curtailment options;
calculate various energy acquisition options for an individual customer;
managing a customer's energy consumption based on an acquisition option selected and predefined curtailment options.
